(19) United States
(12) Patent Application Publication
(10) Pub. No.: US 2007/0019417 A1
(43) Pub. Date: Jan. 25, 2007

(54) Pattern decoration having diffuse ray

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/183,786

(22) Filed: Jul. 19, 2005

(51) Int. Cl. F21V 3/00

(52) U.S. Cl. 362/311

(57) ABSTRACT

The invention relates to a pattern decoration having diffuse ray, which includes a hollow body with an inner lighting source. The decoration has its surface with inner refracting objects, each of which has inclined plane relating to the lighting source. The lighting source emits ray outward to pass through the surface that will form several color diffuse zones on the surface of the decoration for increasing decorative effect.

### FIELD OF THE INVENTION

The present invention relates to a pattern decoration, which includes an inside lighting source to emit ray outward and to form a diffuse effect on the surface of the decoration.

### BACKGROUND OF THE INVENTION

A conventional pattern decoration uses its own pattern outlook to display a normal decorative effect, which will be lost in nighttime. Some products apply an inner lighting source in the transparent decoration to lighten the decoration. Since the ray of the light source will directly pass through the product, this known decoration is still out of special effect.

### SUMMARY OF THE INVENTION

The present invention is to provide a pattern decoration, which includes a lighting source therein to emit the ray through the surface of the decoration with a diffuse effect that increases decorative purpose. Now, accompanying with the following drawings, the character of the present invention will be described here and after.

### BRIEF DESCRIPTION OF THE DRAWINGS

FIG. 1 is a perspective view showing an embodiment of a pattern decoration according to the present invention.

FIG. 2 is a front plan view of FIG. 1.

FIG. 3 is a schematic plan view showing the emitting routes of the lighting ray.

FIG. 4 is an enlarged plan view showing the structure of the surface of the decoration according to the present invention.

### DETAILED DESCRIPTION OF THE PREFERRED EMBODIMENT

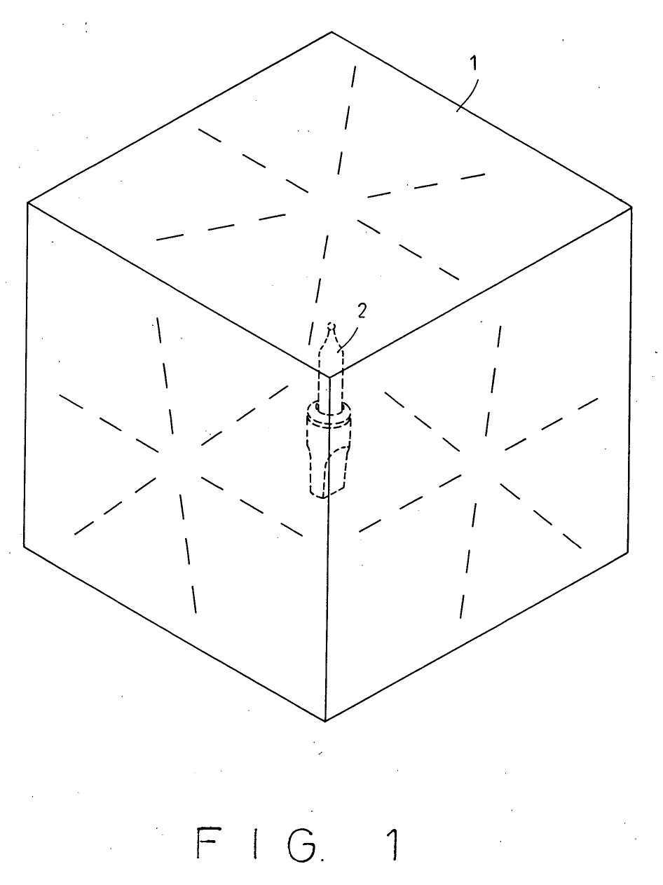

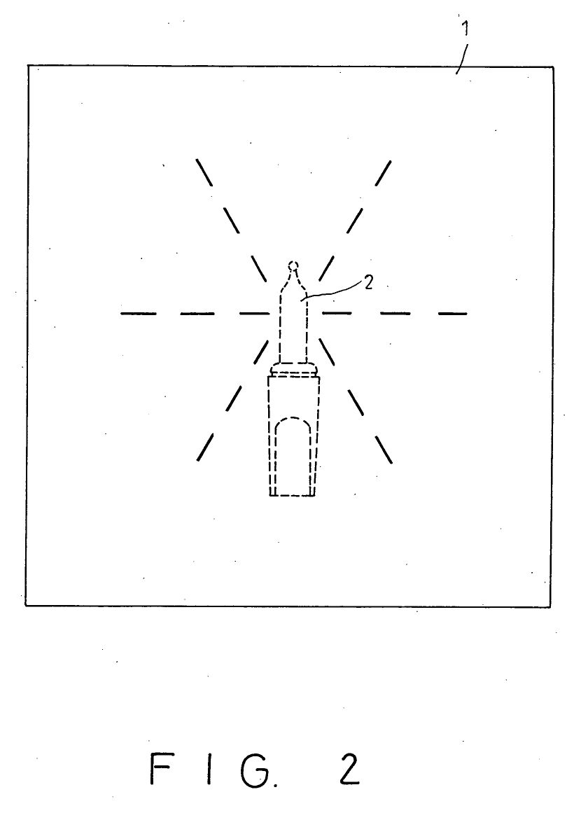

Please refer to FIGS. 1 and 2, the present invention mainly relates to a pattern decoration, which is illustrated as a cube (1) in this embodiment for easy description. The cube (1) is transparent and has an inner light source (2), for example a bulb. The character of the present invention is that the light source (2) emits the ray outward and a diffuse effect will be formed on the surface of the cube (1), as dot lines shown in FIGS. 1 and 2.

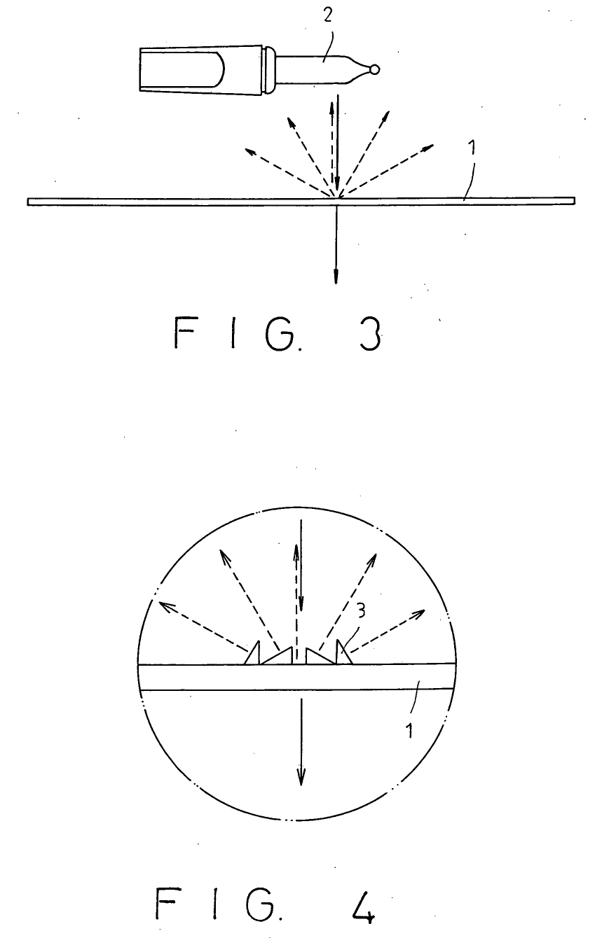

In order to reach the above-mentioned decorative purpose, the cube (1) has its inner surface with several refracting objects (3), as shown in FIGS. 3 and 4. Each refracting object (3) has an inclined plane relating to the light source (2) with 30 degrees or 60 degrees. Therefore, the ray of the light source (2) passes through the surface directly, or is refracted through, or is reflected and then passes through the surface. Due to ray interference, six color diffuse zones are formed on each surface of the cube (1) in this embodiment according to the present invention. It will be found that a beautiful decorative effect is provided under this invention.

The above embodiment is only an exemplary according to the present invention. Under the same invented spirit, any modified design will be claimed in this application, such as to change the pattern of the decorative or to use different inclined plane of the refracting object for various diffuse effect.

I claim:

1. A pattern decoration having diffuse ray including an inner lighting source, wherein the decoration having its inner surface with several refracting objects, each of which has a certain inclined plane relating to the lighting source.
